(19) United States
(12) Patent Application Publication
(10) Pub. No.: US 2006/0116883 A1
(43) Pub. Date: Jun. 1, 2006

(54) Voice guidance system and voice guidance method therefor

(75) Inventors: Michihiro Kawamura, Kanagawa (JP); Kanji Itaki, Kanagawa (JP); Nozomi Noguchi, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/110,799

(22) Filed: Apr. 21, 2005

(30) Foreign Application Priority Data
Nov. 30, 2004 (JP) 2004-345498

(51) Int. Cl. G10L 21/06

(52) U.S. Cl. 704/271

(57) ABSTRACT

A voice guidance system for providing operational guidance using voice in information processing devices that perform desired processing through execution of jobs, comprises a job execution status information acquisition section that acquires job execution status information, and a voice guidance section that performs voice guidance of job status on the basis of the job execution status information acquired by the job execution status information acquisition section.

### BACKGROUND OF THE INVENTION

1. Field of the Invention

The present invention relate to a voice guidance system, and a voice guidance method thereof, for providing operational guidance using voice in information processing devices for performing desired process in accordance with job execution. More particular, the present invention relates to a voice guidance system, and a voice guidance method thereof, for performing voice guidance of job-status.

2. Description of the Related Art

Conventionally, all kinds of information processing devices such as copiers, multifunction devices, personal computers, etc., have been proposed such that the device conforms to a universal design (design of products, associate services and environments easy to be used by as many people as possible, regardless of user age, sex, racial differences or impairments).

In recent years, also, in the wake of the Section 508 of the Rehabilitation Act in the U.S., hardware makers of such information processing devices have become increasingly aware that making equipment more accessible and user-friendly to increased number of people can help boosting corporate competitiveness. This growing awareness is reflected in R&D effort devoted to this aspect.

In this context, various voice guidance technologies have been proposed, in particular for facilitating the activities of visually impaired persons (people with weak eyesight, reduced visual acuity, etc.), for instance as disclosed in JP 2003-140880A.

In JP 2003-140890A, for example, a voice guidance system reports voice guidance regarding “paper out”, “toner low” and “paper jam” while background music (BMG) is played continuously behind that voice guidance. With this voice guidance system, when the user returns after being away from the device, he/she is able to recognize the status that the device is in at that moment.

However, the above information processing devices, for instance multifunction devices, are provided with various functions such as the functions of copy, fax, scanner, etc., in which several jobs may be executed in parallel at the same time. For instance, an external fax signal may be received while a print job started in the operation panel is being executed.

Thus, in the invention of JP 2003-140880A, it may take places that other jobs are also be executed by other users when a job is initiated by a visually impaired person. As a result, it may happen that the job initiated by the visually impaired person is not executed immediately, so the visually impaired person has difficulty in keeping track of the own initiated job and other situations (stand-by, copy in progress, etc.) which can easily be misleading and confusing.

### SUMMARY OF THE INVENTION

The present invention has been made in view of the above circumstances and provides a voice guidance system and a voice guidance method therefor that improves operability and user-friendliness, especially for visually impaired persons, by means of job-status voice guidance.

According to a first aspect of the present invention, a voice guidance system for providing operational guidance using voice in information processing devices that perform desired processing through execution of jobs, comprises a job execution status information acquisition section that acquires job execution status information, and a voice guidance section that performs voice guidance of job status on the basis of the job execution status information acquired by the job execution status information acquisition section.

According to a second aspect of the present invention a voice guidance method in a voice guidance system for providing operational guidance using voice in information processing devices for performing desired processing in accordance with job execution, comprises acquiring job execution status information by way of job execution status information acquisition section, and performing voice guidance for job status by way of job guidance section, on the basis of the job execution status information acquired by the job execution status information acquisition section.

The present invention is so configured that the situation (status) of the jobs being executed is acquired, and on the basis thereof, voice data is synthesized for voice guidance. With the configuration, the users, such as a visually impaired person, etc. can be easily kept informed about the status of jobs, which improves operability and user-friendliness while providing a sense of reassurance to the users.

The voice guidance of the job status can be set up in such a way that voice guidance is performed only for jobs initiated in a visually impaired person dedicated terminal, whereby the status of the own job and the status of other jobs does not get mixed, thus averting confusion to the visually impaired person.

Even when job-status voice guidance is set up in such a way that voice guidance is performed only for jobs initiated in a visually impaired person dedicated terminal, in case of abnormality, voice guidance is performed for all abnormalities. This prevents the visually impaired person from keeping on waiting indefinitely for the execution of a job without being made aware of the abnormality that has occurred.

Abnormalities occurring during job execution are judged to affect or not the progress of jobs initiated in the visually impaired person dedicated terminal, whereupon voice guidance is performed only for those abnormalities that do affect the progress of these jobs. Thus, error messages having no bearing on the execution of the visually impaired person's job are suppressed. This allows further improving operability and user-friendliness by avoiding confusing the visually impaired person.

Also, abnormalities occurring during job execution are decided to be either abnormalities that the visually impaired person him/herself can deal with, or are abnormalities requiring assistance from a collaborator, and then voice guidance is performed on the basis of that decision. As a result, the visually impaired person knows at once whether he/she can solve the abnormality on his/her own, which enables the visually impaired person to cope quickly with such situations.

When abnormalities occur that require assistance from a collaborator, the fact is made known to the machine supervisor by an electronic mail sent automatically. Thus the abnormality can be dealt with quickly even if no collaborators (unimpaired persons) happen to stand nearby when the abnormality occurs.

### BRIEF DESCRIPTION OF THE DRAWINGS

Embodiments of the present invention will be described in detail based on the following figures, wherein:

FIG. 1 is a diagram illustrating the overall constitution to which a voice guidance system according to the present invention is applied;

FIG. 2 is a block diagram illustrating the internal configuration of the multifunction device 1 according to a first embodiment of the present invention;

FIG. 3 is a block diagram illustrating the internal configuration of the visually impaired person dedicated terminal 40 according to the first embodiment;

FIG. 4 is a diagram showing an example of an application screen (copy assistant) displayed on the visually-impaired person dedicated terminal 40;

FIG. 5 is an example of keyboard specification in the visually-impaired person dedicated terminal 40;

FIG. 6 is a sequence chart diagram illustrating the process flow between the multifunction device 1 and the visually impaired person dedicated terminal 40;

FIG. 7 is a flowchart explaining the operation of the job status notification process illustrated in FIG. 6;

FIG. 8 is a block diagram illustrating the internal configuration of a multifunction device 1 according to a second embodiment;

FIG. 9 is a flowchart the operation of a voice guidance system (job status notification processing) according to the second embodiment;

FIG. 10 is a block diagram illustrating the internal configuration of a multifunction device 1 according to a third embodiment;

FIG. 11 is a diagram illustrating an example of an abnormality class information 22b according to the third embodiment;

FIG. 12 is a flowchart the operation of a voice guidance system gob status notification processing) according to the third embodiment; and

FIG. 13 is a diagram illustrating an example of the layout of the operation panel 10.

### DETAIIED DESCRIPTION OF THE INVENTION

Embodiments of the voice guidance system and voice guidance method therefor according to the present invention are described in detail below, with reference to the accompanying drawings.

### EMBODIMENT 1

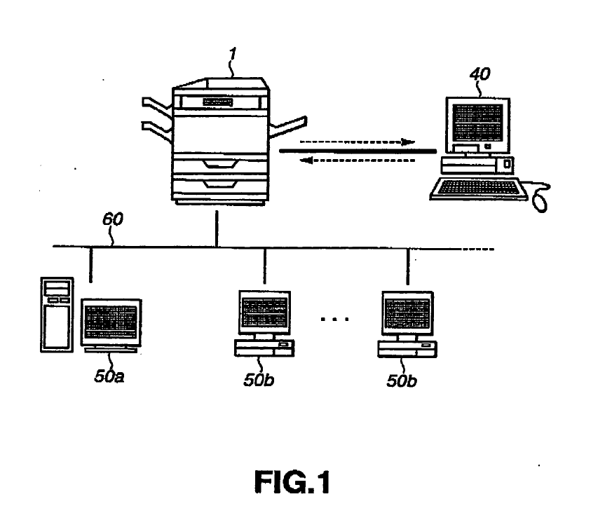

FIG. 1 is a diagram illustrating the overall constitution to which a voice guidance system according to the present invention is applied. In the present embodiment, the present invention is applied to a voice guidance system provided with a multifunction device 1 and a visually impaired person dedicated terminal 40.

This voice guidance system comprises the multifunction device 1, the visually impaired person dedicated terminal 40, and external terminals 50 including a server terminal 50a and client terminals 50b. For explanatory purposes, in the present embodiment, the multifunction device 1 and the visually impaired person dedicated terminal 40 are connected by a USB (Universal Serial Bus), while the multifunction device 1 and the external terminals 50 are connected by a LAN (Local Area Network) 60. However, any connection scheme is employed so long as the functions of the present invention can be performed, and the devices can communicate with each other.

The multifunction device 1 possesses photocopier, fax and scanner functions, and executes jobs run from an operation panel provided in the multifunction device 1, from a client terminal 50b, or from the visually impaired person dedicated terminal 40.

The visually impaired person dedicated terminal 40 is a personal computer operated by a visually impaired person. The visually impaired person can execute different jobs on the multifunction device 1 by running applications on this terminal. The terminal is provided with speakers so that the visually impaired person can easily monitor at any time, through voice guidance, the status of the jobs being executed. The voice guidance also reports on any abnormality occurring in the multifunction device 1.

As mentioned above, the server terminal 50 and the client terminals 50b, i.e. the external terminals 50, are connected to the multifunction device 1 via the LAN 60. The server terminal 50 is a file server, etc. that manages document files and the like, while the client terminals 50b are personal computers operated by the users. For instance, a user operating a client terminal 50b can select a desired document file from the server terminal 50a and can command then a job execution on the selected document file to the multifunction device 1.

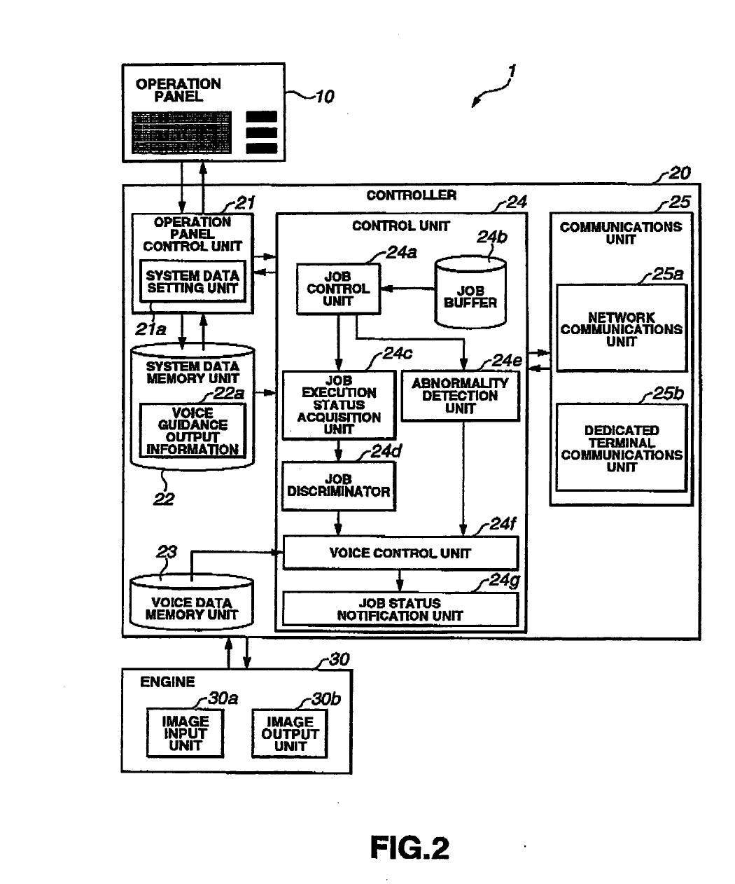

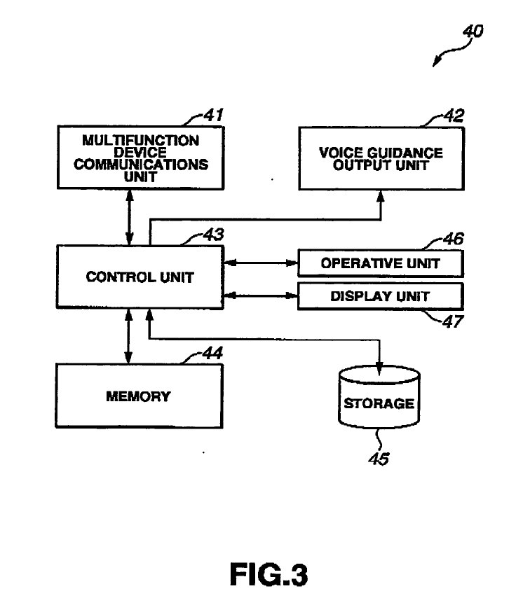

With reference to FIGS. 2 and 3, an outline of the constitution of the multifunction device 1 and the visually impaired person dedicated terminal 40 shown in FIG. 1 is explained below.

FIG. 2 is a block diagram illustrating the internal configuration of the multifunction device 1.

The multifunction device 1 comprises an operation panel 10 that serves as an interface between the user and the multifunction device 1, a controller 20 for integrated control of the multifunction device 1, and an engine 30 for image input/output processing on the basis of the instructions of the controller 20.

The operation panel 10 is a user interface comprising an input device such as a touch screen, a hard-button keypad, etc., and a display device such as an LED (Light Emitting Diode), an LCD (Liquid Crystal Display), etc.

The controller 20 comprises an operation panel control unit 21 for controlling the operation panel 10, a system data memory unit 22 for storing various configuration information related to the operation of the multifunction device 1, a voice data memory unit 23 for storing various voice data, a control unit 24 for managing and controlling the operation of the diverse units, and a communications unit 25 for exchanging data with other devices.

The operation panel control unit 21 is a processing unit for controlling the operation panel 10, for instance, for controlling the display on the operation panel 10 of screens stored in the system data memory unit 22. The operation panel control unit 21 forwards to the control unit 24 the user instructions that the user, based on the above screens, inputs through the input device. A system data setting unit 21a is further provided in the operation panel control unit 21 for recording/setting in the system data memory unit 22 various setting information inputted through the operation panel 10.

The system data memory unit 22 is a storing device for storing various setting information relating to the operation of the multifunction device 1. In the system data memory unit 22, data such as voice guidance output information 22a that covers operative information for voice guidance of only the status of jobs initiated in the visually impaired person dedicated terminal 40, or for voice guidance of the status of all jobs, are stored. This voice guidance output information 22a is recorded/set up in the system data memory unit 22 by the system data setting unit 21.

The voice data memory unit 23 is a storing device for storing various voice data. A voice control unit 24f described below acquires, from data stored in the voice data memory unit 23, data for controlling voice output in accordance with the job execution status.

The control unit 24 is a processing unit for managing and controlling the operation of the various units. Specifically, this control unit 24 issues the instructions for the operation of the processing functional elements that constitute the multifunction device 1. The control unit 24 and the visually impaired person dedicated terminal 40 exchange diverse control signals and data, for instance the transmission of voice data indicating job execution status to the visually impaired person dedicated terminal 40. The control unit 24 comprising a job control unit 24a, a job buffer 24b, a job execution status acquisition unit 24c, a job discriminator 24d, an abnormality detection unit 24e, a voice control unit 24f, and a job status notification unit 24g.

The job control unit 24a is a processing unit for managing and controlling jobs. Specifically, the job control unit 24a generates jobs on the basis of job execution instructions from the client terminals 50b, via the operation panel 10 and the LAN 60, or from the visually impaired person dedicated terminal 40, manages jobs stored on the job buffer 24b, and controls job execution.

The job execution status acquisition unit 24c is a processing unit for acquiring the job execution status of jobs executed in the job control unit 24a. For instance, when the job control unit 24a is executing a copy job, the job execution status acquisition unit 24c acquires the job execution status every time the processing of a document is completed.

The job discriminator 24d is a processing unit form discrimination whether the job being executed in the job control unit 24a is a job initiated in the visually impaired person dedicated terminal 40. When, in accordance with the voice guidance output information 22a stored in the system data memory unit 22, voice guidance is carried out only for the status of jobs initiated in the visually impaired person dedicated terminal 40, the job discriminator 24d determines whether the job being executed is a job initiated in accordance with the voice guidance output information 22a, voice guidance is carried out for the status of all jobs, the job discriminator 24d does not perform such discrimination.

That is, when a plurality of jobs are being executed, if voice guidance is performed for the status of all jobs, the visually impaired person has difficulty in monitoring the status of his/her own job, which may give rise to confusion; thus, the job discriminator decides whether a job is initiated in the visually impaired person dedicated terminal 40 and then voice guidance is performed only for jobs initiated in the visually impaired person dedicated terminal 40.

The abnormality detection unit 24e is a processing unit for detecting abnormalities occurring in the jobs being executed in the job control unit 24a. Herein, voice guidance for the visually impaired person is performed for all detected job abnormalities. That is, if a paper jam occurs during the execution of a job initiated by someone other than the visually impaired person and this is not report by voice guidance, the visually impaired person might keep on waiting indefinitely for the completion of the job without being made aware of the situation.

The voice control unit 24f is a processing unit for synthesizing voice data in response to job execution status or job abnormalities. Various voice data stored in the voice data memory unit are synthesized based on the execution status acquired by the job execution status acquisition unit 24c, or on abnormalities detected by the abnormality detection unit 24e. The synthesized voice data is linked with the job status notification unit 24g, which notifies the voice data to the visually impaired person dedicated in 40 via a dedicated terminal communications unit 25b described below.

The communications unit 25 is an interface device connecting the multifunction device 1 to other devices, and comprises a network communications unit 25a for connecting the multifunction device 1 and the LAN 60, and a dedicated terminal communications unit 25b for connecting the multifunction device 1 and the visually impaired person dedicated terminal 40.

The engine 30 comprises an image input unit 30a such as a scanner device for reading image data formed on paper, etc., and an image output unit 30b such as a printer device for forming image data on paper, etc. This completes the explanation of the functional block diagram illustrating the internal configuration of the multifunction device 1. Though not shown in the figures, the multifunction device 1 may additionally comprise, as needed, a public-link communications unit enabling data exchange via dedicated or public links, a power control unit for controlling the power supply of the components of the multifunction device 1, etc.

FIG. 3 is a block diagram illustrating the internal configuration of the visually impaired person dedicated terminal 40.

The visually impaired person dedicated terminal 40, as mentioned above, is a personal computer operated by a visually impaired person, and is connected to the multifunction device 1 via an intercommunication-enabling USB cable.

The visually impaired person dedicated terminal 40 comprises, as various processing functional elements, a multifunction device communications unit 41 for exchanging data and control signals with the multifunction device 1, a voice guidance output unit 42 (speakers) for outputting the voice data sent by the multifunction device 1, a control unit 43 for integrated control of the visually impaired person dedicated terminal 40, a memory 44 as working area during application execution etc., a storage 45 as storage device, e.g. a HD (hard disk), etc. for storing data including applications, etc., an operative unit 46 such as a keyboard, a mouse etc. for inputting job execution related data, and a display unit 47 such as a display, etc., for visualizing operative screens.

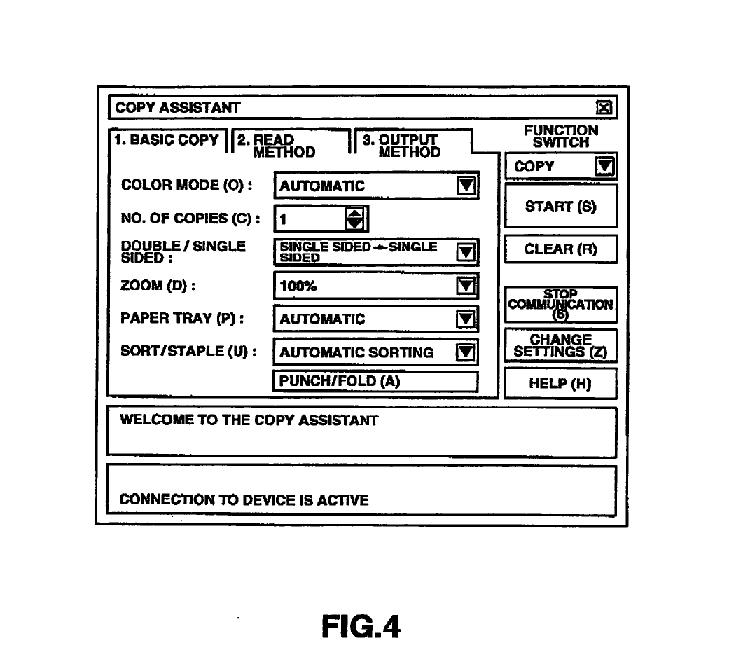

In the display of the display unit 47, application screens such as the one illustrated in FIG. 4 (copy assistant) are visualized. In this screen, different setting values for the execution of the desired copy jobs, fax jobs, scanner jobs, etc can be inputted. In consideration of the visually impaired person, when for instance the mouse is operated so as to move the pointer to the position of single sided/double sided selection, the voice guidance output reads “Switch from single sided to double sided enabled. Possible selections: single sided to single sided, single sided to double sided, double sided to single sided, double sided to double sided”. The visually impaired person, following the voice guidance from the screen, inputs job-execution relevant data, after which the job is executed.

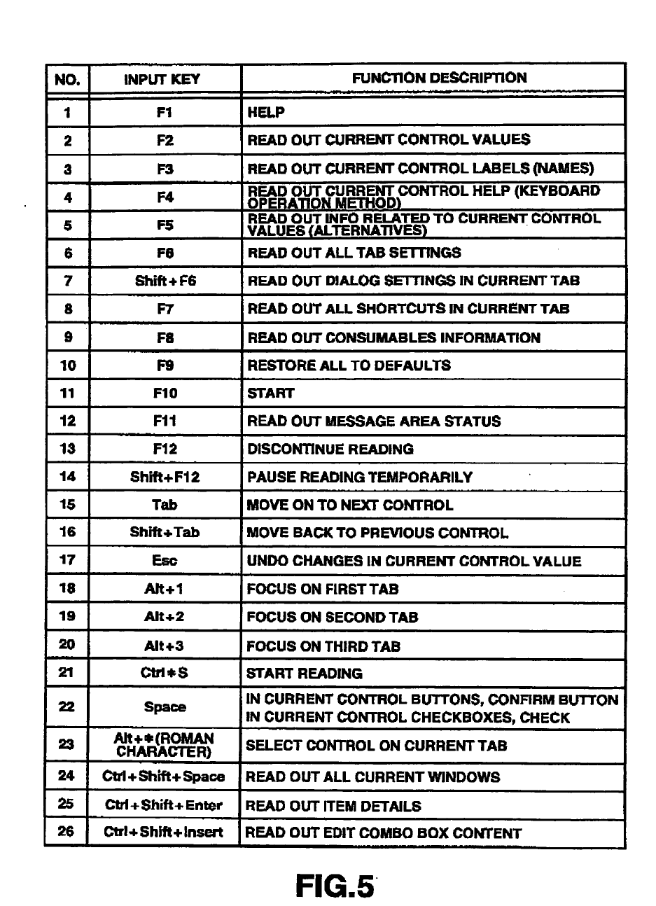

In consideration of the visually impaired person, the keyboard, as the operative unit 46, has a key layout such as the one illustrated in FIG. 5. When for instance “F2” is pressed in the keyboard, the voice guidance reads out the current settings. This completes the explanation of the functional block diagram illustrating the internal configuration of the visually impaired person dedicated terminal 40.

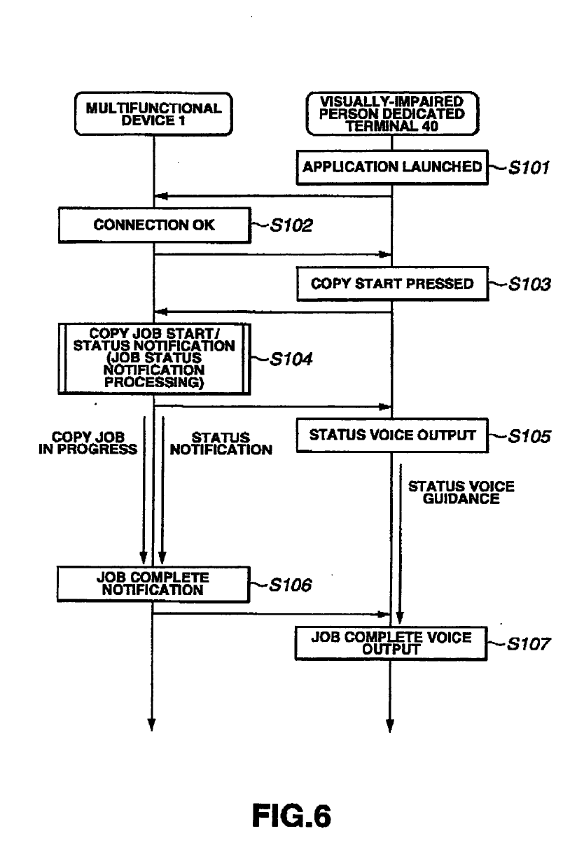

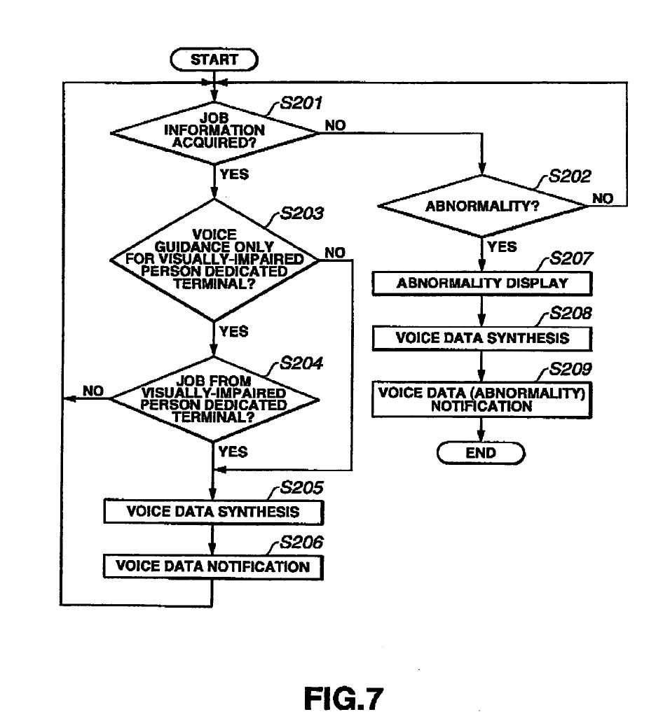

The operation of the voice guidance system according to the present invention is explained next with reference to FIGS. 6 and 7. The explanation herein refers to a copy job performed from the visually impaired person dedicated terminal 40.

FIG. 6 is a sequence chart diagram illustrating the process flow between the multifunction device 1 and the visually impaired person dedicated terminal 40.

First, when the user launches an application in the visually impaired person dedicated terminal 40, a launch notification is sent to the multifunction device 1 (step S101). Having received this launch notification, the control unit 24 in the multifunction device 1 detects that an application was launched in the visually impaired person dedicated terminal 40 and replies that connection is correctly performed (step S102).

The user, such as a visually impaired person, etc., carries out setup in the visually impaired person dedicated terminal 40 in accordance with the voice guidance. Once this operation is over, when the copy start button is pressed, a job execution instruction is sent to the multifunction device (step S103).

When the multifunction device 1 receives this job execution instruction, the job control unit 24a generates and executes the copy job. As the copy job is executed, the voice control unit 24f synthesizes voice data on the basis of the job execution status acquired by the job execution status acquisition unit 24c. The synthesized voice data is linked with the job status notification unit 24g, which sends the synthesized voice data to the visually impaired person dedicated terminal 40 (step S104).

In accordance with the received voice data, voice guidance is then outputted by the voice guidance output unit 42 in the visually impaired person dedicated terminal 40, thereby notifying the user about the job execution status (step S105). The actions of steps S104 and S105 are performed continually until job completion, thereby allowing the user such as a visually impaired person, etc. to be informed at all times about the job execution status.

When the copy job is finished in the multifunction device 1, a copy job completion notification is sent to the visually impaired person dedicated terminal 40 (step S106). Along with this notification, voice guidance in the visually impaired person dedicated terminal 40 informs the user that the copy job is completed (step S107), thereby ending the process.

The detailed operation of the step S104, job status notification processing, is explained in detail next with reference to FIG. 7. The job status notification processing is initiated at the same time as a job starts being executed in the job control unit 24a of the multifunction device 1. When this process is initiated, job execution is monitored until the job execution status acquisition unit 24c acquires the status of the job being executed (NO in step S201), or until the abnormality detection unit 24e detects an abnormality in the job being executed (after NO in step S201, NO in step S202).

When the job execution status acquisition unit 24c acquires the status of the job being executed (YES in step S201), the multifunction device 1 determines whether to carry out voice guidance only for the jobs started in the visually impaired person dedicated terminal 40 or for all jobs (step S203). This decision is made herein by the control unit 24 on the basis of the voice guidance out information 22a stored beforehand in the system data memory unit 22.

If voice guidance is to be carried out for the status of all jobs according to the setting of the voice guidance output information 22a (NO in step S203), the voice control unit 24f synthesizes voice data based on the job execution status acquired by the job execution status acquisition unit 24c (step S205). If voice guidance is to be carried out only for the status of jobs started in the visually impaired person dedicated terminal 40 according to the setting of the voice guidance output information 22a (YES in step S203), the job discriminator 34d determines whether the job being executed was initiated in the visually impaired person dedicated terminal 40 (step S204).

If the job discriminator 34d determines that the job being executed was not initiated in the visually impaired person dedicated terminal 40, but somewhere else (NO in step S204), the process returns to step S201 and job execution is monitored again; if the job discriminator 34d determines that the job being executed was initiated in the visually impaired person dedicated terminal 40 (YES in step S204), the voice control unit 24f synthesizes voice data based on the job execution status acquired by the job execution status acquisition unit 24c (step S205), and at the same time, the synthesized voice data is linked with the job stanzas notification unit 24g, which notifies the voice data to the visually impaired person dedicated terminal 40 (step S206). Along with this notification, the process returns to step S201 and job execution is monitored again. This process is continually repeated throughout the job execution so that job-status voice guidance is carried out in the visually impaired person dedicated terminal 40.

In accordance with the received voice data, voice guidance is then issued by the voice guidance output unit 42 in the visually impaired person dedicated terminal 40. If for instance a copy job involving multiple documents is executed, the voice guidance reads “first document copy complete”, “second document copy completed”, and “All document copies complete” for the last document. Thus the user such as a visually impaired person, etc. can be easily kept informed about the status of the jobs.

If an abnormality in the job being executed is detected by the abnormality detection unit 24e (after NO in step S201, YES in step S202), the abnormality occurrence is linked to the operation panel control unit 21, and the latter displays in the operation panel 10 that an abnormality has oared in the job being executed (step S207).

As the operation panel 10 reports the abnormality occurrence, the voice control unit 24f synthesizes voice data based on the abnormality that has occurred (step S208). The synthesized voice data is linked with the job status notification unit 24g, which notifies the voice data to the visually impaired person dedicated terminal 40 (step S209). The process in the multifunction device 1 finishes with this notification. When such abnormalities happen, voice guidance is performed in the visually impaired person dedicated terminal 40 for all abnormalities occurring in the multifunction device 1 regardless of the information (own job or other jobs) set up in the voice guidance output information 22a. This prevents the visually impaired person from keeping on waiting indefinitely for the execution of a job without being made aware of the abnormality.

In the present invention, as explained above, the situation of the jobs being executed is acquired, and on the basis thereof, voice data is synthesized for voice guidance, at any time, in the visually impaired person dedicated terminal 40. Thereby, the user such as a visually impaired person, etc. can be easily kept informed about the status of jobs, which improves operability and user-friendliness while providing a sense of reassurance to the user.

Also, the voice guidance of the job status can be set up in such a way that voice guidance is performed only for jobs initiated in the visually impaired person dedicated terminal 40, whereby the status of own jobs and the status of other jobs does not get mixed, thus averting confusion to the visually impaired person

Furthermore, even when job-status voice guidance is set up so as to perform voice guidance only for jobs initiated in the visually impaired person dedicated terminal 40, in case of abnormality voice guidance is performed for all abnormalities. This prevents the visually impaired person from keeping on waiting indefinitely for the execution of a job without being made aware of the abnormality that has occurred.

### EMBODIMENT 2

In the embodiment 1, an instance is explained wherein, in case of abnormality, voice guidance is performed or all abnormalities. In the embodiment 2, an embodiment will be explained wherein among abnormalities in the multifunction device 1, voice guidance is performed only for those abnormalities affecting the status of a job initiated in the visually impaired person dedicated terminal 40.

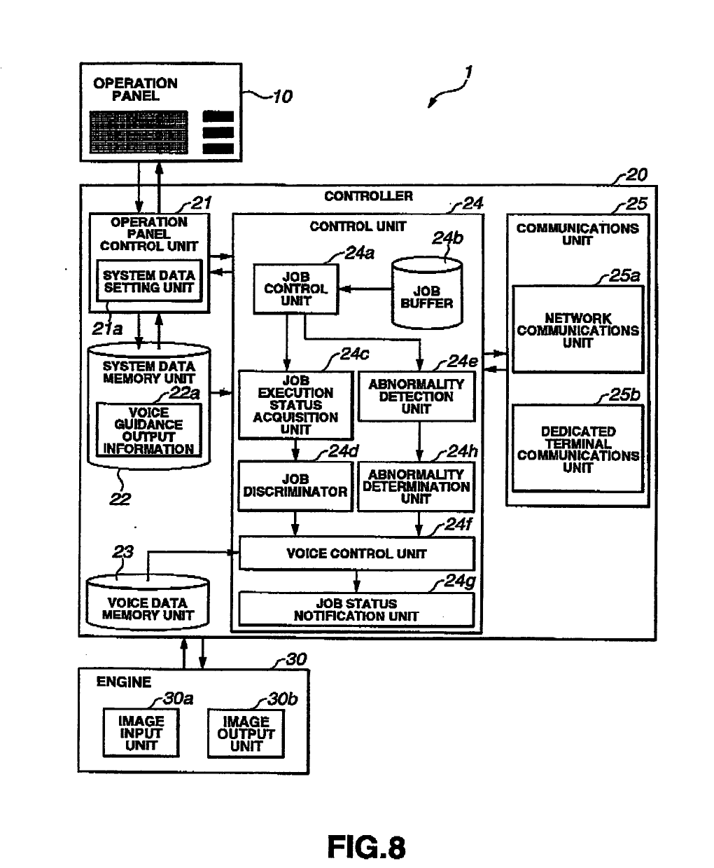

FIG. 8 is a block diagram illustrating the internal configuration of a multifunction device 1 according to the embodiment 2. The components with reference numerals identical to those of the embodiment 1 explained in FIG. 2 denote identical components operated in a substantially identical way, for which reason they are not described again herein and only the differences between the two embodiments are explained.

Roughly, the multifunction device 1 comprises an operation panel 10, a controller 20, and an engine 30. Except for the controller 20, this constitution is identical to the one explained in FIG. 2.

The controller 20 comprises an operation panel control unit 21, a system data memory unit 22, a voice data memory unit 23, a control unit 24, and a communications unit 25. Except for the control unit 24, the controller 20 is identical to the one explained in FIG. 2.

In addition to the constitution of the embodiment 1, the control unit 24 comprises also an abnormality determination unit 24h.

The abnormality determination unit 24h is a processing unit for determining whether detected abnormalities can affect the progress of a job initiated in the visually impaired person dedicated terminal 40. If the abnormality determination unit 24h decides that the abnormality does not affect the progress of a job initiated in the visually impaired person dedicated terminal 40, no voice data notifying the abnormality is sent to the visually impaired person dedicated terminal 40 and no voice guidance is performed.

In case of 2 or more paper feed trays, for instance, the removal of a paper feed tray not being used by a job initiated in the visually impaired person dedicated terminal 40 does not affect the progress of that job. In such a case, the abnormality determination unit 24h decides that the abnormality does not affect the progress of a job initiated in the visually impaired person dedicated terminal 40. By contrast, abnormalities such as cover opening, etc. are judged to affect the progress of a job initiated in the visually impaired person dedicated terminal 40. This completes the explanation of the functional block diagrams illustrating the internal configuration of the multifunction device 1 according to the embodiment 2. The internal configuration of the visually impaired person dedicated terminal 40 according to the embodiment 2 is identical to that of the embodiment 1 explained in FIG. 3, so its explanation is not repeated herein.

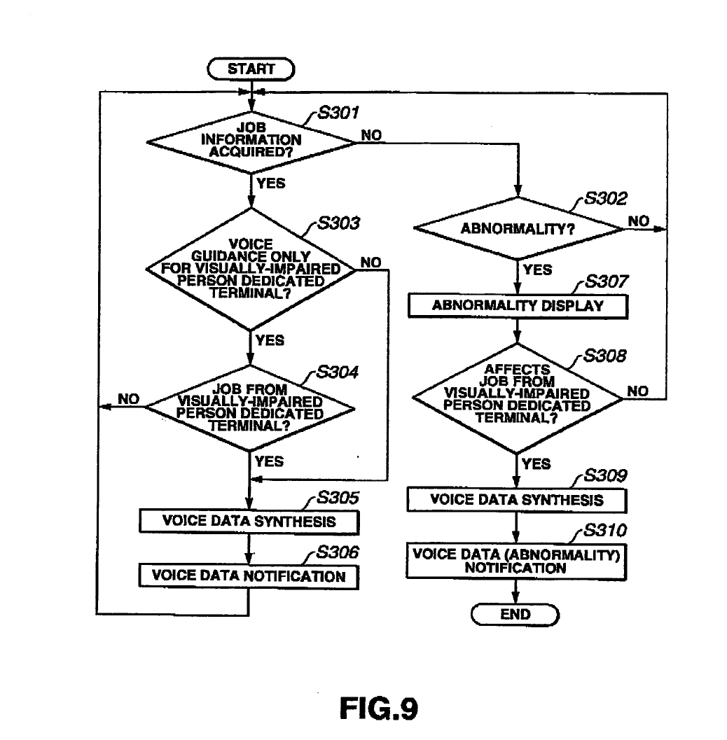

The operation of the voice guidance system according to the embodiment 2 is explained next with reference to FIG. 9. The process flow between the multifunction device 1 and the visually impaired person dedicated terminal 40 is substantially identical to the one explained in FIG. 6 for the embodiment 1, so only step S104 (see FIG. 6) of job status notification processing will be explained.

The job status notification processing is initiated at the same time as the job start being executed in the job control unit 24a of the multifunction device 1. When this process is initiated, the job execution is monitored until the job execution status acquisition unit 24c acquires the status of the job being executed (NO in step S301), or until the abnormality detection unit 24e detects an abnormality in the job being executed (after NO in step S301, NO in step S302).

When the job execution status acquisition unit 24c acquires the status of the job being executed (YES in step S301), the multifunction device 1 determines whether to carry out voice guidance only for the jobs started in the visually impaired person dedicated terminal 40 or for all jobs (step S303).

This decision is made herein by the control unit 24 on the basis of the voice guidance output information 22a stored beforehand in the system data memory unit 22.

If voice guidance is to be carried out for the status of al jobs (NO in step S303) according to the setting of the voice guidance output information 22a, the voice control unit 24f synthesizes voice data based on the job execution status acquired by the job execution status acquisition unit 24c (step S305). If voice guidance is to be carried out only for the status of jobs started in the visually impaired person dedicated terminal 40 according to the setting of the voice guidance output information 22a (YES in step S303), the job discriminator 34d determines whether the job being executed was initiated in the visually impaired person dedicated terminal 40 (step S304).

If the job discriminator 34d determines that the job being executed was not initiated in the visually impaired person dedicated terminal 40, but somewhere else (NO in step S304), the process returns to step S301 and job execution is monitored again; if the job discriminator 34d determines that the job being executed was initiated in the visually impaired person dedicated terminal 40 (YES in step S304), the voice control unit 24f synthesizes voice data based on the job execution status acquired by the job execution status acquisition unit 24c (step S305), and at the same time. The synthesized voice data is linked with the job status notification unit 24g, which notifies the voice data to the visually impaired person dedicated terminal 40 (step S306). Along with this notification, the process returns to step S301 and job execution is monitored again. This process is continually repeated throughout the job execution so that job-status voice guidance is carried out in the visually impaired person dedicated terminal 40.

In accordance with the received voice data, voice guidance is then issued by the voice guidance output unit 42 in the visually impaired person dedicated terminal 40. If for instance a copy job involving multiple documents is executed, the vice guidance reads “first document copy complete”, second document copy complete, and “All document copies complete” for the last document. Thus the user such as a visually impaired person, etc. can be easily kept informed about the status of the jobs.

If an abnormality in the job being executed is detected by the abnormality detection unit 24e (after NO in step S301, YES in step S302), the abnormality occurrence is linked to the operation panel control unit 21, and the latter displays in the operation panel 10 that an abnormality has occurred in the job being executed (step S307).

As the operation panel 10 reports the abnormality occurrence, the abnormality determination unit 24h determines whether the abnormality affects the progress of a job initiated in the visually impaired person dedicated teal 40.

If the abnormality determination unit 24h determines that the abnormality does not affect the progress of a job initiated in the visually impaired person dedicated terminal 40 (NO in step S308), the process returns to step S301 and job execution is monitored again.

On the other hand, if the abnormality determination unit 24h determines that the abnormality affects the progress of a job initiated in the visually impaired person dedicated terminal 40 (YES in step S308), the voice control unit 24f synthesizes voice data based on the abnormality that has occurred (step S309). The synthesized voice data is linked with the job status notification unit 24g, which notifies the voice data to the visually impaired person dedicated terminal 40 (step S309). The process in the multifunction device 1 finishes with this notification. When such abnormalities happen, voice guidance is performed in the visually impaired person dedicated terminal 40 only for abnormalities that affect jobs initiated in the visually impaired person dedicated terminal 40, thereby avoiding confusion to the visually impaired person on account of abnormalities not relevant to that person.

In the embodiment 2 it is judged whether abnormalities occurring during job execution in the multifunction device affect or not the progress of jobs initiated in the visually impaired person dedicated terminal 40, whereupon voice guidance is performed in the visually impaired person dedicated terminal 40 only for those abnormalities that do affect the progress of these jobs. Error messages having no bearing on the execution of unaffected jobs are thus suppressed. This allows improving operability and user-friendliness by avoiding confusing the visually impaired person

### EMBODIMENT 3

In the embodiment 1, an instance is explained when, in case of abnormality, voice guidance is performed for all abnormalities. In the embodiment 3, an embodiment will be explained in which abnormalities that can occur in the multifunction device 1 are classified into abnormalities that the user (visually impaired person) can deal with on his/her of and abnormalities that require assistance from a collaborator, and wherein voice guidance is modified accordingly upon abnormality occurrence.

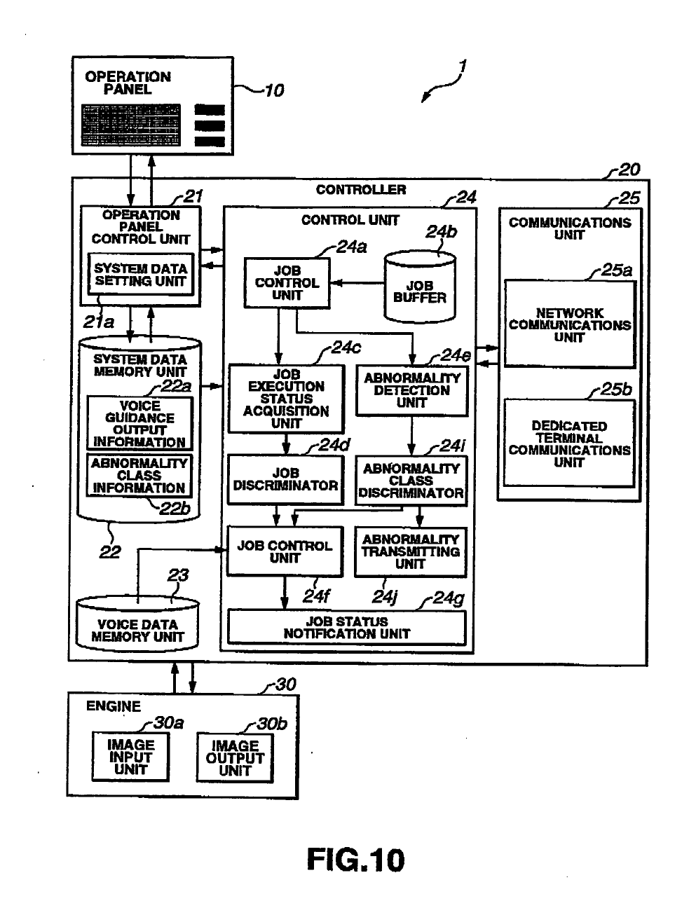

FIG. 10 is a block diagram illustrating the internal configuration of a multifunction device 1 according to the embodiment 3. The components with reference numerals identical to those of the embodiment 1 explained in FIG. 2 denote identical components operated substantially in an identical way, for which reason they are not described again herein and only the differences between the two embodiments are explained.

Roughly, the multifunction device 1 comprises an operation panel 10, a controller 20, and an engine 30. Except for the controller 20, this constitution is identical to the one explained in FIG. 2.

The controller 20 comprises an operation panel control unit 21, a system data memory unit 22, a voice data memory unit 23, a control unit 24, and a communications unit 25. Except for the system data memory unit 22 and the control unit 24, the controller 20 is identical to the one explained in FIG. 2.

The system data memory unit 22 is a storage device for storing setting information related to the operation of the multifunction device 1.

The system data memory unit 22 stores, in addition to the voice guidance output information 22a, abnormality class information 22b in which the abnormalities that can occur in the multifunction device 1 are classified.

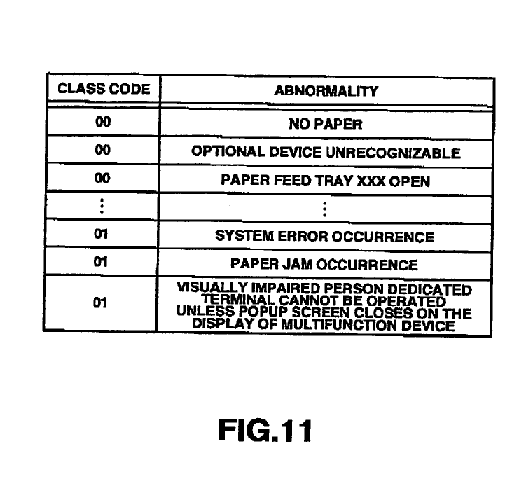

The information encompassed by the abnormality class information 22b can be divided into abnormalities that the visually impaired person can deal with on his/her own, and abnormalities requiring assistance from a collaborator. Abnormalities can be cataloged for instance in accordance with the class codes listed in FIG. 11. Herein, abnormalities that the visually impaired person can deal with on his/her own are assigned the class code: 00, while abnormalities requiring assistance from a collaborator are assigned the class code: 01. The abnormality class information 22b, like the voice guidance output information 22a, is recorded/set up in the system data memory unit 22 by the system data setting unit 21a, in such a way that abnormalities can be classified, in accordance with the usage environment or as desired by the user, by modifying the class code.

Abnormalities that can be dealt with by the visually impaired person him/herself refer herein to abnormalities that can be solved through basic operations such as power ON/OFF, paper replenishment, toner replacement, card insertion/removal, coin insertion, setting of original documents, etc. On the other hand, abnormalities that require assistance from a collaborator refer herein to abnormalities other than the above, for instance, internal abnormalities such as paper jams, abnormalities requiring the intervention of maintenance personnel abnormalities that require acting on the operation panel 10 (not possible from the visually impaired person dedicated terminal 40), etc.

In the control unit 24, an abnormality class discriminator 24i, and an abnormality transmitting unit 24j are provided, in addition to the constitution of the embodiment 1.

The abnormality class discriminator 24i is a processing unit for, on the basis of the aforementioned abnormality class information 22b, discriminating the abnormalities detected by he abnormality detecting unit 24e between abnormalities that can be dealt with by the visually impaired person him/herself and abnormalities requiring assistance from a collaborator. In case of abnormalities that can be dealt with by the visually impaired person him/herself the voice guidance in the visually impaired person dedicated terminal 40 informs on how to deal with the abnormality, while in case of abnormalities requiring assistance from a collaborator, the voice guide in the visually impaired person dedicated terminal 40 prompts calling a collaborator.

The abnormality transmitting unit 24j is a processing unit for notifying by electronic mail the abnormality occurrence to the equipment supervisor, etc., in case the abnormality class discriminator 24i determines that the abnormality requires assistance from a collaborator. The electronic mail destination must be pre-recorded in the system data memory unit 22, thought it may be changed so as to send notifications to parties other than the equipment supervisor, such as other users, a support center, etc. This completes the explanation of the functional block diagram showing the internal configuration of the multifunction device 1. The internal configuration of the visually impaired person dedicated terminal 40 according to the embodiment 3 is identical to that of the embodiment 1 explained in FIG. 3, so its explanation is not repeated herein.

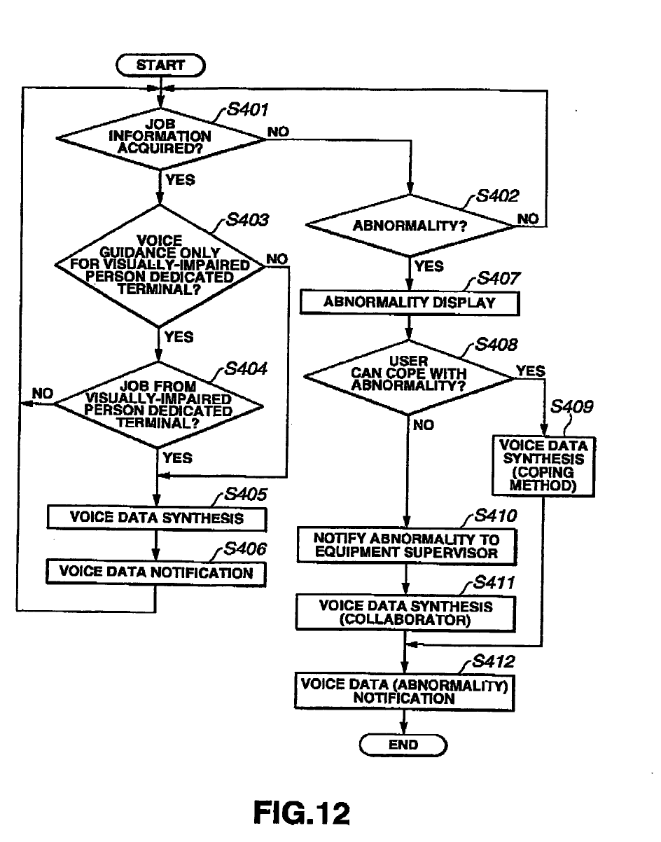

The operation of the voice guidance system according to the embodiment 3 is explained next with reference to FIG. 12. The process flow between the multifunction device 1 and the visually impaired person dedicated terminal 40 is substantially identical to the one explained in FIG. 6 for the embodiment 1, so only step S104 (see FIG. 6) of job status notification processing will be explained

The job status notification processing is initiated at the same time as the job starts being executed in the job control unit 24a of the multifunction device 1. When this process is initiated, job execution is monitored until the job execution status acquisition unit 24c acquires the status of the job being executed (NO in step S401), or until the abnormality detection unit 24e detects an abnormality in the job being executed (after NO in step S401, NO in step S402).

When the job execution status acquisition unit 24c acquires the status of the job being executed (YES in step S401), the multifunction device 1 decides whether to carry out voice guidance only for the jobs started in the visually impaired person dedicated terminal 40 or for all jobs (step S403). This decision is made herein by the control unit 24 on the basis of the voice guidance output information 22a stored beforehand in the system data memory unit 22.

If voice guidance is to be carried out for the status of all jobs according to the setting of the voice guidance output information 22a (NO in step S403), the voice control unit 24f synthesizes voice data based on the job execution status acquired by the job execution status acquisition unit 24c (step S405). If voice guidance is to be carried out only for the status of jobs started in the visually impaired person dedicated terminal 40 according to the setting of the voice guidance output information 22a YES in step S403), the job discriminator 34d determines whether the job being executed was initiated in the visually impaired person dedicated terminal 40 (step S404).

If the job discriminator 34d determines that the job being executed was not initiated in the visually impaired person dedicated terminal 40, but somewhere else (NO in step S404), the process returns to step S401 and job execution is monitored again; if the job discriminator 34d determines that the job being executed was initiated in the visually impaired person dedicated terminal 40 (YES in step S404), the voice control unit 24f synthesizes voice data based on the job execution status acquired by the job execution status acquisition unit 24c (step S405), and at the same time, the synthesized voice data is linked with the job status notification unit 24g, which notifies the voice data to the visually impaired person dedicated terminal 40 (step S406). Along with this notification, the process returns to step S401 and job execution is monitored again. This process is continually repeated throughout the job execution so that job-status voice guidance is carried out in the visually impaired person dedicated terminal 40.

In accordance with the received voice data, voice guidance is then issued by the voice guidance output unit 42 in the visually impaired person dedicated terminal 40. If for instance a copy job involving multiple documents is executed, the voice guidance reads “first document copy complete”, “second document copy complete”, and “All document copies complete” for the last document. Thus the user such as a visually impaired person, etc. can be easily kept informed about the status of the jobs.

If an abnormality in the job being executed is detected by the abnormality detection unit 24e (after NO in step S401, YES in step S402), the abnormality occurrence is linked to the operation panel control unit 21, and the latter displays in the operation panel 10 that an abnormality has occurred in the job being executed (step S407).

As the operation panel 10 reports the abnormality occurrence, the abnormality type discriminator 24i determines whether the abnormality is an abnormality that can be dealt with by the visually impaired person him/herself or is an abnormality requiring assistance from a collaborator (step S408). This decision is made herein by the control unit 24 on the basis of the voice guidance output information 22a stored beforehand in the system data memory unit 22.

If the abnormality type discriminator 24i determines that the abnormality can be dealt with by the visually impaired person him/herself (YES in step S408), the voice control unit 24f synthesized voice data corresponding to how to solve the abnormality (step S409). The synthesized voice data is linked with the job status notification unit 24g, which notifies the voice data to the visually impaired person dedicated terminal 40 (step S412). The process in the multifunction device 1 finishes with this notification.

In accordance with the received voice data, the voice guidance output unit 42 in the visually impaired person dedicated terminal 40 outputs voice guidance on how to solve the abnormality. In a copy job, for instance, if the original document is not detected correctly, the voice guidance may read “Please place correctly original document on the document glass and press then the Start button, or press the Cancel button and reset the original docent in the automatic document-sending device”. Thus, when an abnormality occurs that can be solved by basic operations, the instructions and advice of the voice guidance enable the visually impaired person to solve him/herself the abnormality, thereby making the system more user-friendly.

If the abnormality type discriminator 24i determines that the abnormality requires assistance from a collaborator (NO in STEP S408), the control unit 24 generates an electronic mail concerning the abnormality and sends it from the abnormality transmitting unit 24j, via the network communications unit 25a, to the equipment supervisor (step S410). Next, the voice control unit 24f synthesizes voice data for prompting the visually impaired person to call a collaborator (step S411); the synthesized voice data is linked with the job status notification unit 24g, which sends the synthesized voice data to the visually impaired person dedicated terminal 40 (step S412). The process in the multifunction device 1 finishes with this notification.

On the basis of the received voice data, the voice guidance output unit 42 in the visually impaired person dedicated terminal 40 outputs the voice guidance that prompts calling a collaborator. In case of a paper jam, for instance, the voice guidance may read “A paper jam has occurred. Please request assistance”. Along with this voice guidance, a notification of the abnormality and/or a help message for solving the abnormality may also be displayed on the operation panel 10 of the multifunction device 1, as reference for the collaborator when solving the abnormality. After the collaborator has solved the abnormality in the multifunction device 1 proper, messages prompting a reboot or a job restart may also be displayed. Thus, since the voice guidance prompts calling a collaborator when abnormalities occur that are difficult to deal with by the visually impaired person him/herself the visually impaired person knows at once whether he/she can solve the abnormality on his/her own. This enables the visually impaired person to cope quickly with such situations.

In the embodiment 3 described above, there is provided abnormality classification data 22b for classifying the abnormalities that may occur in the multifunction device 1. Whether the visually impaired person him/herself can deal with the abnormalities, or the abnormality requires assistance from a collaborator, is decided on the basis of that data, and then voice guidance is performed in accordance with that decision. As a result, the visually impaired person knows at once whether he/she can solve the abnormality on his/her own. This enables the visually impaired person to cope quickly with such situations.

When abnormalities occur that require assistance from a collaborator the fat is made known to the machine supervisor by an epic mail sent automatically. Thus the abnormal can be dealt with quickly even if no collaborators (unimpaired persons) happen to stand nearby when the abnormality occurs .

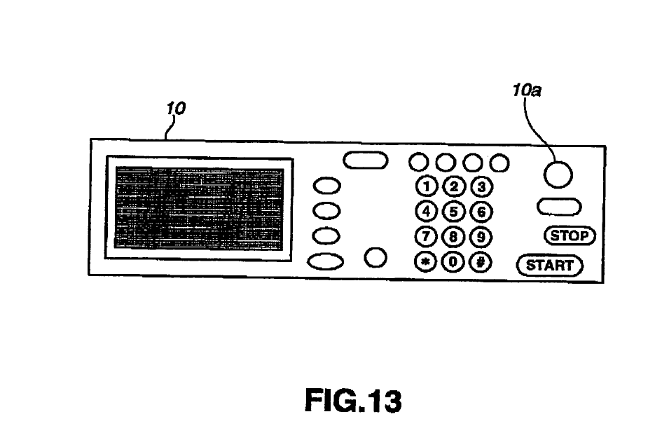

In the embodiments 1 through 3, instances were described in which job execution is done with the visually impaired person initiating the job in the visually impaired person dedicated terminal 40, The embodiments, however, are not limited thereto; for example, the input device (operating buttons) of the operation panel 10 may be provided with a visually impaired person button 10a, as shown in FIG. 13, such that when the button is pressed the visually impaired person can also execute jobs in the multifunction device 1. In this case, when the visually impaired pa button 10a is pressed, the above-described voice guidance issues from speakers provided in the multifunction device 1.

In the embodiments 1 through 3, instances were also described in which voice data was synthesized in the multifunction device 1. The embodiments, however, are not limited thereto; for example, voice data may also be synthesized in the visual impaired person dedicated terminal 40 on the basis of job execution status acquired by the multifunction device 1.

In the embodiments 1 through 3, instances were also described in which the voice guidance system according to the present invention was used in the multifunction device 1 and the vary impaired person dedicated terminal 40. The embodiments, however, are not limited thereto; for example, the voice guidance system can also be used in personal computers, etc.

While the present invention has been described by way of the embodiments and accompanying drawings above, it is to be distinctly understood that the invention is not limited thereto; from the foregoing description, moreover, it will be apparent that such embodiments can accommodate all manner of modifications without departing from the spirit and scope of the invention. For instance, though the voice guidance system according to the present invention was explained by way of the embodiments 1 through 3, the invention may also be implemented incorporating all the above embodiment or partial combinations thereof.

The voice guidance system and voice guidance method therefor according to the present invention can be widely used in all kinds of information processing devices, and can be particularly effective in improving office environments, making them more work-friendly for visually impaired persons (people with weak eyesight, reduced visual acuity, etc.)

The entire disclosure of Japanese Patent Application No. 2004-345498 filed on Nov. 30, 2004 including specification, claims, drawings and abstract is incorporated herein by reference in its entirety.

What is claimed is:

1. A voice guidance system or providing operational guidance using voice in information processing devices that perform desired processing through execution of jobs, comprising:
a job execution status information acquisition section that acquires job execution status information, and
a voice guidance section that performs voice guidance of job status on the basis of the job execution status information acquired by the job execution status information acquisition section.

2. A voice guidance system according to claim 1, further comprising:
a visually-impaired person dedicated terminal for use by visually impaired persons; and
a discrimination section that determines whether a job is initiated in the visually impaired person dedicated terminal, wherein
the voice guidance section performs voice guidance for the job status of the job when the discrimination section determines that the job is initiated in the visually impaired person dedicated terminal.

3. A voice guidance system according to claim 2, further comprising a setting section that performs setting as to whether voice guidance is selectively performed or not for the job status of jobs determined by the discrimination section as being initiated in the visually impaired person dedicated terminal, wherein
the voice guidance section selectively performs voice guidance for the job status of jobs determined by the discrimination section as having been initiated in the visually impaired person dedicated terminal when the setting section sets that voice guidance is to be performed for the job status of only jobs initiated in the visually impaired person dedicated terminal, and
the voice guidance section performs voice guidance for the job status of all jobs on the basis of the job execution status information acquired by the job execution status information acquisition section when the setting section does not set that voice guidance is to be performed for the job status of only jobs initiated in the visually impend person dedicated terminal.

4. A voice guidance system according to claim 1, further comprising a detection section that detects an abnormality in a job to be executed, wherein
the voice guidance section performs voice guidance for the abnormality detected by the detection section

5. A voice guidance system according to claim 4, wherein, in the setting by the setting section that voice guidance is to be performed for the job status of only jobs initiated in the visually impaired person dedicated terminal, if the detection section detects an abnormality in another job, voice guidance is performed for the abnormality in the another job.

6. A voice guidance system according to claim 4, further comprising a determination section that determines whether or not a job abnormality detected by the detection section affects the progress of jobs initiated in the visually impaired person dedicated terminal, wherein
the voice guidance section performs voice guidance for a job abnormality detected by the detection section when the determination section determines that the job abnormality detected by the detection section affects the progress of jobs initiated in the visually impaired person dedicated terminal.

7. A voice guidance system according to claim 4, wherein the voice guidance section performs voice guidance to the effect of calling a collaborator when performing the voice guidance for the abnormality.

8. A voice guidance system according to claim 4, fiber comprising an abnormality setting section that sets an abnormality detected by the detection section as a first abnormality requiring assistance from a collaborator, or a second abnormality not requiring assistance from a collaborator, wherein
the voice guidance section performs voice guidance to the effect of calling a collaborator when the detection section detects a first abnormality, and the voice guidance section performs voice guidance indicating how to deal with the abnormality in performing the voice guidance for the abnormality when the detection section detects a second abnormality.

9. A voice guidance system according to claim 4, further comprising a display device that displays the abnormality in performing the voice guidance for the abnormality by the voice guide section.

10. A voice guidance system according to claim 7, filer comprising notification section that automatically notifies the abnormality through electronic mail to an administrator when the voice guidance section performs voice guidance to the effect of calling a collaborator.

11. A voice guidance method in a voice guidance system for providing operational guidance using voice in information processing devices for performing desired processing in accordance with job execution comprising
acquiring job execution status information by way of job execution status information acquisition section, and
performing voice guidance for job status by way of job guidance section, on the basis of the job execution status information acquired by the job execution status information acquisition section.
